(19) United States
(12) Patent Application Publication
(10) Pub. No.: US 2012/0185212 A1
(43) Pub. Date: Jul. 19, 2012

(54) METHOD AND SYSTEM FOR PREPARING SENSOR OUTPUT DATA OF A SENSOR ASSEMBLY FOR FURTHER PROCESSING IN AT LEAST ONE APPLICATION AND/OR BY AT LEAST ONE ALGORITHM

(75) Inventor: Cecilia Ekelin, Goteborg (SE)

(73) Assignee: VOLVO TECHNOLOGY CORPORATION, Goteborg (SE)

(21) Appl. No.: 13/498,622

(22) PCT Filed: Sep. 29, 2009
(86) PCT No.: PCT/SE09/00429

§ 371 Date: Mar. 28, 2012

(51) Int. Cl. G06F 15/00

(52) U.S. Cl. 702/182

(57) ABSTRACT

A method and a system are provided for preparing sensor output data of a sensor assembly comprising at least one sensor for further processing in at least one application and/or by at least one algorithm. The method includes a configuration phase and an operational phase. The operational phase includes: Providing a data manipulation structure comprising a filter function for transforming the sensor output data into processable sensor data and at least a first memory function for storing the processable sensor data; Transforming the sensor data from the sensor assembly into processable sensor data processable by the at least one application and/or the at least one algorithm by means of the filter function; Storing the processable sensor data by means of the at least first memory function; Providing the stored processable sensor data to the at least one application and/or the at least one algorithm for further processing.

The present invention relates to a method and a system for preparing sensor output data of a sensor assembly for further processing in at least one application and/or by at least one algorithm. The sensor assembly comprises at least one sensor. Such methods and systems can be used in many different technological fields, applications and mobile or immobile systems and objects as for instance in the automotive field or in surveillance systems or in any other system having a sensor network.

Today, in automotive vehicles it is common and well-known to have active-safety applications such as an adaptive cruise control or a lane departure warning system. These applications rely on output data from several kinds of sensors such as radars, cameras and speed sensors, in order to compute a model of the vehicle environment. For the computation of the model of the vehicle environment, the sensor output data need to be transformed into a format which can be processed by the applications.

According to the known state of the art, in vehicles equipped with such applications which usually are connected to the vehicle's CAN-bus, the applications read the required sensor output data directly from the CAN-bus to which the sensor of interest is connected and transform the data into a format that is suited for the further processing or computation of the data in such applications. The disadvantage of these known solutions is that each application has to perform this computation individually. This in turn reduces the overall efficiency of the systems in the vehicle.

Moreover, since each application is directly connected to the sensors, each update or replacement of the sensors requires an update of the applications which is time-consuming and increases the risk for programming errors.

Additionally, since the input signals of the sensors can be more or less accurate, it is desirable to combine and evaluate the output data of the sensors by means of a suitable algorithm, a so called fusion algorithm. Such fusion algorithms are well-known and adapted to compare and to evaluate sensor output data, e.g. based on a signal processing theory such as Kalman filters, and to provide information on the confidence of these evaluated sensor output data. Disadvantageously, the computational power requirements for a processor executing such a fusion algorithm are quite high since the comparing and evaluating process is computationally intense.

Beside the fusion algorithm, there can be other algorithms, which prepare data sets from the sensor output data, which in turn are used or needed by the applications. Particularly, the algorithm provides data which are necessary for a plurality of applications, wherein the data are usually provided by the applications themselves. A further example for such an algorithm is a road friction estimating algorithm.

However, these algorithms and in particularly the fusion algorithm need specific information of each individual sensor of the sensor assembly the output data of which they are supposed to process, i.e. to compare and to evaluate. In case a sensor is replaced, e.g. due to maintenance reasons or because a more accurate sensor type is available, or a new sensor is added to the sensor assembly, the fusion algorithm concerned needs to be updated as well, i.e. the program of the fusion algorithm has to be amended. This in turn increases again the risk of programming errors.

It is therefore an object of the present invention to provide a method and system for interconnecting sensor assemblies and applications that enables an improved preparation of the sensor output data of the sensor assemblies for further processing in said applications.

According to a further object of the invention, a method and system for interconnecting sensor assemblies and applications is desired, which also provides sensor output data to a fusion algorithm for evaluation of the sensor output data, and which further provides the results of the executed fusion algorithm to the applications.

A further object of the present invention is to provide a method and system, wherein, regardless which algorithm is used, the algorithm has access to the sensor output data, and the computation of this algorithm can be executed fast enough in order to be able to keep the risk that data jam occur as low as possible.

These objects are achieved by a method according to claim 1, a system according to claim 9, a vehicle according to claim 19, and computer program products according to claims 20 and 21.

The invention is based on the idea to introduce a data manipulation structure for manipulating “raw” sensor output data, directly read from a sensor assembly comprising at least one sensor, into processable sensor data, which are processable by at least one application and/or at least one algorithm. The processable data are in a more general format than the “raw” sensor output data and can therefore be used by a plurality of different applications or algorithms without further pre-processing.

One major advantage is that the general format of the processable data prepared by the method and the system according to the invention enables a separation of the processing of the sensor output data from the generation of the raw sensor output data and makes the functioning of the applications and algorithms independent from the actual sensor configuration, so that the sensor assembly can be changed without the necessity to also adapt the applications or algorithms using the sensor output data.

The inventive method and system is based on a process with two phases. In the first phase, the configuration phase, the data manipulating structure is generated. In the second phase, the operational phase, the method prepares the processable sensor data for an application and/or algorithm from the output sensor data by means of the data manipulating structure. The two phases provide each an individually inventive solution so linked with each other as to form a single general inventive concept, since the data manipulation structure is preferably generated only in case the sensor assembly is used the first time or the sensor assembly has been changed but is a prerequisite for the functioning of the subsequent operational phase otherwise. Therefore, a method and system according to the invention comprises the solutions for the configuration phase and the operational phase individually as well as their combination.

The data manipulation structure comprises a filter function that transforms the sensor output data into processable sensor data, and at least a first memory function, a so-called blackboard, that stores the processable sensor data. From the first memory function or blackboard, the processable sensor data are available for further processing by both the applications and/or algorithm.

The filter function and/or the at least first memory function can be realised as software or hardware implementation, but the software implementation is preferred as it provides more flexibility.

During the configuration phase, the data manipulation structure itself, i.e. the filter function and the at least first memory function, is automatically generated wherein the configuration phase is preferably only performed, when the sensor assembly is used the first time or if a change in the sensor assembly has taken place, i.e. at least one sensor has been added, removed or exchanged. In this configuration phase, the filter function is automatically generated based on a set of data derived from a sensor assembly specification and sensor data specification file (hereinafter referred to as “sensor and data specification file”), wherein the set of data includes filter function data for automatically configuring the filter function. Additionally or alternatively, the set of data may further include memory function data for automatically configuring the at least first memory function during the configuration phase.

The sensor and data specification file is manually programmed, the first time the sensor assembly is used or each time the sensor configuration has changed e.g. by adding, removing or exchanging one or more sensors, or the whole sensor assembly has been replaced by a new sensor assembly. It is also possible that the sensor assembly is adapted to automatically generate and transmit the sensor and data specification file.

By introducing the automatically generated filter and memory functions, the invention provides a method and a system which are independent on the current specification of the sensor assembly used, as the data transformed by the filter function and stored in the memory function are generic. This in turn means that a change in the sensor assembly affect only the filter function, which is based on the sensor and data specification file, but not the applications or algorithm, in particular fusion algorithms, using the actual sensor output data.

This is also advantageous in situations where a new sensor is added to, an existing sensor is removed from, or an existing sensor is exchanged in a sensor assembly comprised in a system. In systems known from the state of the art, this would require updates of all individual system elements, particularly of the applications and of the algorithms, in particular fusion algorithms used. Even if the system elements still need to have information on the change in the sensor assembly, the inventive method and system facilitate this process, as, in the configuration phase, the source code for the filter function and the memory function are automatically generated based on the sensor and data specification file corresponding to the used sensor assemblies. Therefore, the code generation not only simplifies the processing of the sensor output data but also reduces the risk of programming errors.

Additionally, the risk of data losses and data inconsistencies can be considerably reduced as the filter function stores the processable sensor data in the memory function only when all corresponding sensor output data have been transformed to processable sensor data.

According to a preferred embodiment of the invention, the data manipulation structure further comprises a second memory function which is adapted to store a second set of processable sensor data, i.e. replicated processable sensor data or further processed processable sensor data. Preferably, the second memory function is a replica of the first memory function, meaning that the sets of data stored in these memory functions can be, preferably automatically, replicated between the two memory functions.

Preferably, the applications and the algorithms, in particular fusion algorithms used are provided with processable sensor data from either the first or the second memory function.

As can be seen from a further preferred embodiment of the invention, the filter function and the first memory function can be implemented in a first node and the second memory function in a second, separate node. Such a node can correspond to an electronic control unit (ECU) of an immobile object as for instance a surveillance system or of a mobile object as for instance a vehicle, such as a car, truck, boat, train, airplane, or construction vehicle.

In a further preferred embodiment of the invention, the system comprises a first node and a second node, which are connected with each other, e.g. by a wired or wireless communication connection. Additionally, the first node is connected to the sensor assembly arranged at the sensed object (as for instance a vehicle) through a further wired or wireless data communication connection, such as a CAN-bus, and is adapted to execute the filter function and first memory function as well as one or more applications. The second node is adapted to execute the second memory function and one or more algorithms, in particular fusion algorithms.

It goes without saying that the first node can also be connected to at least one algorithm and the second node can be connected to at least one algorithm, or both, nodes A and node B are connected to either applications or algorithms.

The advantage of this distribution of the various functions, algorithms and tasks between different nodes is that the nodes can be more easily adapted to the different requirements and specifications of the individual functions, algorithm or tasks. For example, a fusion algorithm usually requires powerful processing capabilities, so that the node which is adapted to perform the fusion algorithm preferably should also have a powerful processor while certain application(s) as for instance a climate control usually do not necessarily need such powerful processor(s) so that in the corresponding node(s) less powerful, but usually also less expensive processor(s), can be used which in turn could reduce the overall cost for such a system.

Additionally, the computation of the fusion algorithm by an individual processor also allows the use of less powerful processors in application(s), which usually require a powerful processor, as for instance an adaptive cruise control (ACC). This is due to the fact that the major part of the computational power required by the ACC is used for calculating an evaluation of the received sensor data. Since this computation step is done by the fusion algorithm on a different processor, the computational power of the processor used in the ACC can be reduced correspondingly.

Further advantages and preferred embodiments of the inventions are defined by the dependent claims, the description and the appending figures.

In the following, preferred embodiments of the system according to the invention will be discussed with the help of the attached Figures. The description of the Figures is considered as exemplification of the principles of the invention and is not intended to limit the scope of the claims.

The Figures show:

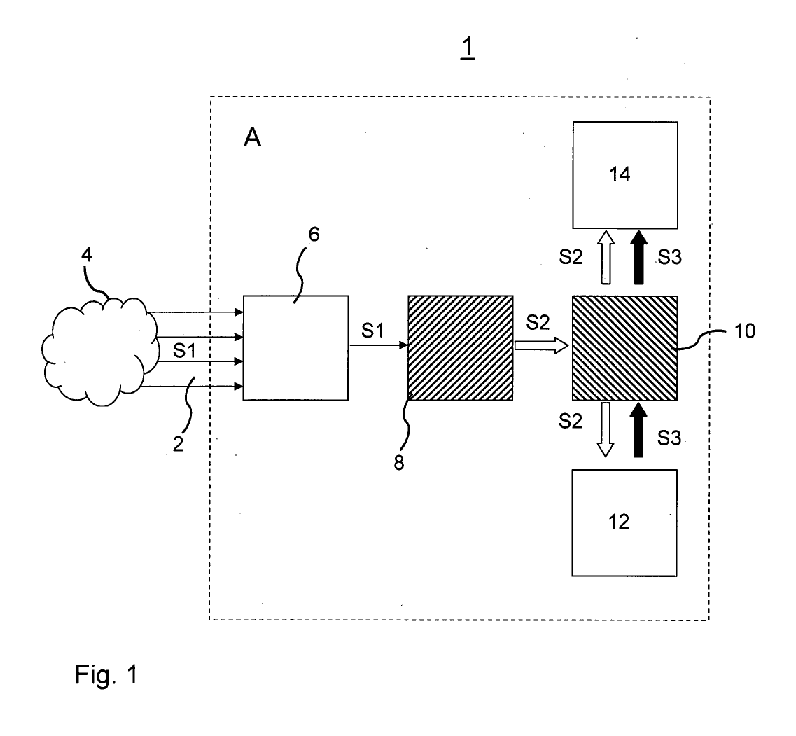

FIG. 1: a schematic illustration of a first preferred embodiment of the inventive system; and

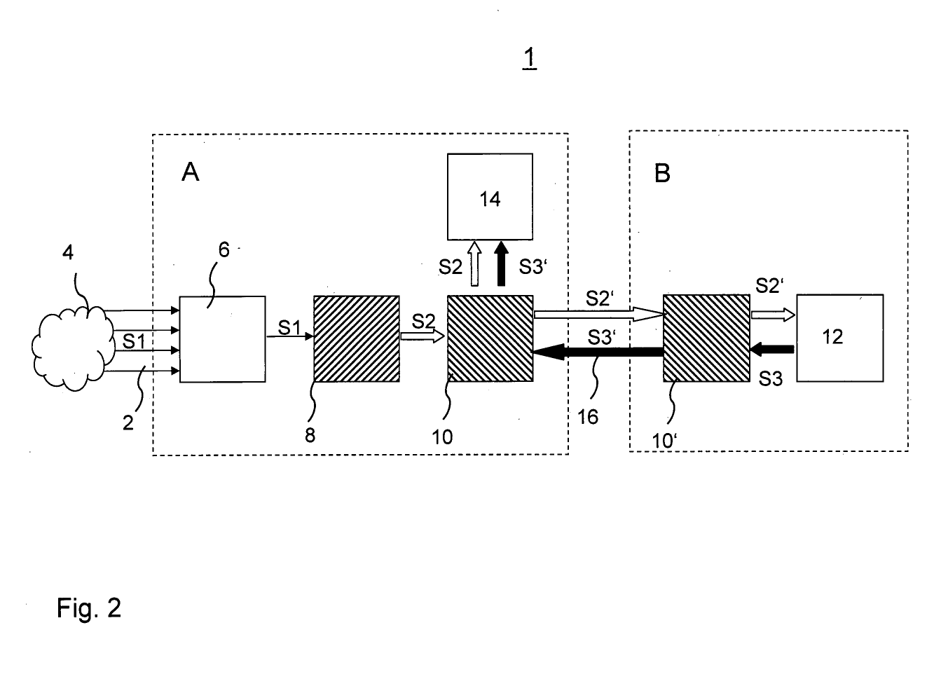

FIG. 2: a schematic illustration of a second preferred embodiment of the inventive system.

In the following, the preferred embodiments illustrated in the Figures will be described in relation to their use in a vehicle, wherein identical or corresponding elements are indicated by the same reference numerals. This is done due to clarity and simplicity reasons and should not be understood as limiting the scope of the protection of the invention. The inventive method and system can also be used in any other system having a sensor assembly, the output data of which shall be processed by an application and/or an algorithm.

FIG. 1 shows a schematic illustration of the principle of the present invention according to a first preferred embodiment. In the illustrated embodiment of the inventive system 1, a first node A, e.g. comprised in a vehicle (not shown), is connected via at least one CAN-bus 2 to a sensor assembly 4.

Usually, there are several CAN-busses in a vehicle, since the vehicle network architecture is separated into different sub-systems, e.g. first and second sensor assemblies. This allows for instance to have CAN-busses with different speeds or to prevent certain data to be seen by all applications. Additionally, particularly in connection with the sensor assemblies, the data amount produced by a sub-system can be very large so that the sub-system requires a dedicated individual CAN-bus.

In vehicles usually a CAN-bus architecture is used, but the vehicle may also, or alternatively, be equipped with LIN, MOST or a FleyRay bus architectures or any other suitable wired or wireless data communication connections. The sensor assembly 4 can comprise a single sensor but also a plurality of sensors. Such a sensor assembly 4 can comprise e.g. vision sensors, such as a camera, radar sensors and speed sensors which provide information on the surrounding of the vehicle.

The “raw” sensor output data S1 provided by the sensor assembly 4 are transmitted via the CAN-bus 2 to node A, or more specific, to a CAN-reader module 6, which is implemented in the node A and is adapted to read the “raw” sensor output data S1 from the CAN-bus 2. Subsequently, the “raw” sensor output data S1 are supplied from the CAN-reader module 6 to a filter function 8 which transforms the “raw” sensor output data S1 into processable sensor data S2.

The “raw” sensor output data S1 can come from one or more sensors connected to the CAN-bus 2. The “raw” sensor output data S1 are usually comprised in so-called CAN-frames which in turn include an identifier identifying the CAN-frame (CAN-id) and a data part. The CAN-id is supposed to be unique for each sensor of the sensor assembly 4 providing sensor output data S1. Therefore, the CAN-id identifies the type of sensor sending the CAN-frame. Additionally, the CAN-id is used by the CAN-bus protocol itself to determine priorities among CAN-frames in case there are simultaneous transmissions from different sensors. Usually, the CAN-id is an 11-bit (or 29-bit) number.

Additionally, the CAN-reader module 6 may be adapted to add a CAN-bus identification (Bus-id) to the CAN-frame, if there is more than one CAN-bus available. The Bus-id and the CAN-frame are then supplied to the filter function 8. The Bus-id can further be used to distinguish between sensors in the case the CAN-ids of their sensor output data are overlapping. That means, if, for example, the vehicle is equipped with two identical radar sensors which are mounted at the front of the vehicle and one radar sensor is looking to the left and the other radar sensor to the right, and each radar sensor is connected to its dedicated individual CAN-bus, the radar sensors would use the same CAN-id for their sensor output data. The reason for that is that these radar sensors are usually of the same type, even if one sensor contains data from the left side of the vehicle and the other sensor contains data from the right side of the vehicle. Consequently, without the use of a further identifier, e.g. the Bus-id, it would be impossible for the filter function 8 or any other processing tool to distinguish between the two radar sensors by just looking at the CAN-id.

Based on the CAN-id and, if suitable, the Bus-id, the filter function 8 identifies the incoming individual CAN-frames and determines which sensor they are coming from and then extracts the sensor output data S1 from these frames. Information about which CAN-frames belong to which sensor and what kind of sensor output data will be extracted from these CAN-frames is specified in a sensor and data specification file, which has been used to generate the filter function 8 in a configuration phase preceding the normal operation of the system 1. The configuration phase will be explained in detail further below.

The filter function 8 transforms the “raw” sensor data S1 by reading each CAN-frame supplied from the CAN-reader module 6. Based on the CAN-id and if available the bus-id, data pieces comprising the actually sensed sensor output data are extracted from the CAN-frame. Since usually the sensed sensor output data cannot be stored in a single CAN-frame due to their size, the sensor output data are chunked into data pieces and theses data pieces are distributed over a plurality of CAN-frames. As soon as all CAN-frames comprising the various data pieces of said sensor output data have been received and read, these data pieces are stored as elements of a sensor data object (i.e. a data structure that contains all the data the sensor delivers) in a first blackboard (first memory function) 10, wherein the stored sensor data object in turn provides the processable sensor data S2.

Since, as explained above, the data from one sensor are typically spread over several CAN-frames, the use of the sensor data object in the first memory function 10 and the automatic filtering in the filter function 8 provides a simplified way for any application or algorithm to access the transformed sensor output data in a well defined format and to further process these now easily “processable” data.

The filter function 8 and the at least first memory function 10 can be regarded as data manipulating structure (the components of the data manipulation structure are indicated in FIG. 1 by the hatched rectangles), wherein the data manipulation or the transformation from “raw” sensor output data S1 to processable sensor output data S2 are performed by a processor (not shown) comprised in the node A.

The data manipulation structure itself is automatically generated during a configuration phase that is performed prior to the normal operation of the system 1.

During this configuration phase, the filter function 8 and the at least first memory function 10 are automatically generated based on the sensor and data specification file(s) of the sensor(s) making up the sensor assembly 4.

Generally, the sensor and data specification file can be a file F consisting of several well-defined parts. A first part I which specifies how the filtering and storage of data should be done, and a second part II which specifies the details of the CAN-frames. The second part II can be directly taken as an output from a commercial software tool as, for instance a software tool called “CANalyzer” provided by Vector Informatik GmbH (http://www.vector.com/portal/medien/cmc/datasheets/CANalyzer_DataSheet_DE.pdf). Further parts may be added with further specifications (see example further below).

The source code for the filter function 8 and the first memory function 10 is generated by an automated program (compiler) which takes the file F as input and translates the specification constructs into a number of files containing the source code for the filter function 8 and the first memory function 10. A construct in this context is a functional structure part of a program file using a well-defined syntax and semantics similar to e.g. an if-then-else construct or a loop-construct of a programming language. The compiler can be regarded as a batch/command line program with no user interaction and it is preferably written in the programming language C so that the source code generated is also in this language C.

In a preferred embodiment, the sensor and data specification file can preferably comprise the following parts I, II and III:

In a first part I at least one fusion data object can be defined each of which may contain at least one data element and provides data for a fusion algorithm. In case a fusion algorithm will not be used, this part is not necessary. The data elements contained in the at least one fusion data object are supposed to be stored in the first memory function 10 and used by a fusion algorithm. This also implies that these data might be replicated from a second memory function (10′ in FIG. 2) to the first memory function 10, in case not only one but two memory functions are used (this case will be described more in detail further below in connection with the embodiment of the invention depicted in FIG. 2).

A second part II of the file relates to the corresponding sensor. Here, the specification constructs are a bit more complex since the second part II also needs to handle the filtering function 8. The second part II can be subdivided into three subparts II-1 II-2 and II-3.

In the first sub-part II-1, it is specified for each sensor, which CAN-frames contain the data from which sensor and on which CAN-bus they will arrive, e.g. three CAN-messages (MSG_1, MSG_2 and MSG_3) from the sensor in question may arrive on CAN-bus A. The CAN-bus on which they arrive is identified when these systems are installed in the vehicle. The CAN-frames may arrive in any order, which can be indicated by e.g. a keyword such as “random”, but ordered sequences are also possible. The information what kind of messages can be expected on which CAN-bus is used for the generation of the filter function 8.

In a next sub-part II-2 it is specified which data signals contained in the CAN-frames are to be extracted. The extraction during run time of the data manipulation structure works as follows: A temporary copy of the sensor data object is provided to which the CAN-frames are extracted during the collection of the corresponding sensor output data. If the temporary sensor data object is completed i.e. all necessary CAN-frames have been received and are read, the temporary sensor data object is stored as final sensor data object in the memory function 10. This ensures that the sensor data object of the memory function 10 always contains the complete data. This complete sensor data object can then be replicated to the other available memory functions 10′. This information is also used for the generation of the filter function 8.

In a final part II-3, the sensor data object which will be stored in, the memory function 10 (see sub-part II-2) is specified. This specification also implies that data will be replicated from the first memory function 10 to the second memory function 10′ (see description regarding FIG. 2 below).

The above described constructs are made for each sensor or fusion data which is included in the system. The sensor can be e.g. a vision sensor, and the fused data object can e.g. represent an enhancement, particularly an increase in the level of a precision or confidence, of this sensor based on other sensors.

If the CAN-frames and data signals are given by name, the filter function-8 needs to know which CAN-ids the names represent and which bits in the CAN-frame the signal names represent. This kind of information is available in a so-called CAN-specification file that is usually available for each sensor. The CAN-specification file corresponds for instance to an output file from the CANalyzer software and is produced during the integration of the various sensors of the sensor assembly into the vehicle system architecture. This CAN-specification file is forming part III of the sensor and data specification file, so that the compiler of the sensor and data specification file can extract the information that is needed for the filter generation.

The generated filter function 8 and the at least one memory function 10 can then be implemented or uploaded into the node A. Preferably, for this purpose a remote processor (for instance comprised in a separate computer, such as a laptop or an xPC Target computer (see xPC Target 4.2 data sheet available from http://www.mathworks.com/products/xpctarget/?BB=1)), is connected to the node A, for instance via Ethernet.

After the configuration of the data manipulation structure in the configuration phase comprising the filter function 8 and at least one first memory function 10, in the subsequent normal operational phase of the system, the filter function 8 automatically transforms the raw sensor output data. S1 and stores them as transformed processable sensor data S2 in the first memory function 10 provided that the sensor and data specification file of the existing sensor assembly 4 (implemented in the vehicle) is not changed or the sensor assembly 4 is not replaced by a new sensor assembly.

However, if the sensor and data specification file of the existing sensor assembly 4 is changed or said sensor assembly 4 is replaced by a new sensor assembly, the data manipulation structure has to be re-configured in a new configuration phase based on the new sensor and data specification file of the existing sensor assembly 4 or of the new replacement sensor assembly, as the case may be.

Since the accuracy of sensor output signals S1 provided by the sensor assembly 4 can vary, it is desirable to combine and compare these sensor output data S1 of the sensors by means of a specifically designed algorithm, the so called fusion algorithm. For this purpose, the processable sensor data S2 are provided to a fusion algorithm 12 for evaluation, and the result of this evaluation is output as further processed processable data S3 (in case the further processed processable sensor data S3 are evaluated by a fusion algorithm the data are also called evaluated processable sensor data S3). The fusion algorithm 12 can be a computer program which is also executed by the processor of the node A, but it is also possible and in certain applications preferable, if node A comprises a second processor which only runs the fusion algorithm 12, as the fusion algorithm 12 usually needs a lot of computation power. The fusion algorithm 12 is adapted to compare the processable sensor data S2, e.g. based on a signal processing theory such as Kalman filters, and is also adapted to provide information on the confidence of the sensor data processed by said fusion algorithm, namely the evaluated processable data S3. Since the fusion algorithm 12 has access to all processable sensor data S2 and provided that the fusion algorithm is executed fast enough, the risk that an unwanted data jam occurs is reduced considerably.

Further, node A comprises an application 14, which can also be executed by the processor of node A, which processes the processable sensor data S2. For example, the sensor output data S1 of a vision sensor, a radar sensor and a speed sensor provide information on the vehicle's environment which can be used as input for e.g. an adaptive cruise control system or a lane departure warning system. Since, as explained above, the sensor output data S1 can be too inaccurate for the application 14 to produce reliable results, the use of such a fusion algorithm 12 is often required for such applications 14. The fusion algorithm 12 provides these applications 14 with the evaluated processable sensor data S3 and information about the confidence of these data in order to overcome the inherent problems with the needed accuracy of the sensor output signals S1 and to enhance the reliability and robustness of the output of such applications 14. The fusion algorithm 12 can e.g. generate a model on the vehicles environment which can also be used by the application 14. Additionally, the fusion algorithm can evaluate the sensor data and give an estimate or confidence on the accuracy of the sensor data.

FIG. 2 shows a further preferred embodiment of the invention. Here, the embodiment of the inventive system 1 comprises not only a single node A, as shown in FIG. 1, but also a second node B, which is connected to the first node A via a wireless or wired data communication connection 16, e.g. Ethernet. Additionally, the data manipulation structure further comprises a replica of the first memory function 10 in form of a second memory function 10′. The second memory function 10′ is also automatically generated during the configuration phase, and is implemented or uploaded to the inventive system 1 (as described above).

Again, as already described above, there is a sensor assembly 4 providing sensor output data S1, which are input into node A, preferably read by a CAN-reader module 6. The “raw” sensor output data S1 are then transformed by the filter function 8 into processable sensor data S2, which are stored in a first memory function 10.

The difference between the embodiment illustrated by FIG. 1 and the embodiment illustrated by FIG. 2 is that, in the embodiment of FIG. 2, the second node B comprises a second memory function 10′, which has been generated during the configuration phase and which can be a replica of the first memory function 10. It should be noted that even if in the illustrated embodiment the second memory function 10′ is comprised in the second node B, it is also possible to have only a single node, which comprises both memory functions 10, 10′.

The processable sensor data S2 are replicated, preferably by an asynchronous data replication, in order to provide the same data in the first memory function 10 and in the second memory function 10′. Thereby, the same data are made available in node A and node B. Additionally or alternatively, it is possible that only those data are replicated which have been accessed by node A or node B, whereby computation time and power can be saved.

Alternatively, it is also possible to provide a central storage which is connected to node A and node B, and provides, upon request, the data to node A and/or node B. Thereby, storage space can be saved. However, the use of a central storage may result in longer response times for the data access compared with the solution using a data replication.

The replication is performed in the following way: Whenever a data object (sensor output data or fusion algorithm data) is stored in either the first memory function 10 (on node A) or the second memory function 10′ (on node B), the memory function 10; 10′ concerned will transmit this newly stored data object via the data communication connection 16 between node A and B to its replicated memory function 10′; 10 on the respective other node, where it is stored and is available for applications 14 or the fusion algorithm 12, respectively. The source code needed for the replication is also generated during the configuration phase.

Preferably, the replication is an asynchronous replication. Using asynchronous replication, both the memory function 10 and its replicated memory function 10′ does not necessarily provide at the same time the same content. When for instance processable sensor data S2 generated by the filter function 8 are transmitted from the memory function 10 to its replicated memory function 10′, the memory function 10 does not need to wait until the replicated memory function 10′ has stored all replicated processable sensor data S2′. The filter function 8 can continue to store additional processable sensor data S2 in the memory function 10, even if the process of storing the preceding replicated processable sensor data S2′ in the memory function 10′ has not been finished yet.

The second node B also comprises a processor (not shown), which is adapted to perform either the fusion algorithm or the application. The distribution of system elements to at least two nodes has the advantage that each node or the processor(s) of the nodes can be designed for and adapted to the computer program to be executed on it/them. For example, since the fusion algorithm 12 usually needs more computational power than e.g. the filter function 8, the node which runs the fusion algorithm 12 should also have a processor that is more powerful than the processor for the filter function 8.

In this context, it should be noted that e.g. the application 14 can also be performed on e.g. a separate third node C (not shown), which is connected to the first node A, and can further be adapted to the computational needs of the application 14. In this case, preferably, a third memory function is integrated in such a node C, which is preferably a replica of the first memory function 10 and comprises replicated data from the first memory function 10 and the second memory function 10′.

It should be further noted that one node can also comprise more than one memory function or can comprise more than one processor for increasing the computational power of the node. It goes without saying that any other configuration of a data manipulation structure having at least one filter function 8 and at least one memory function 10 is also encompassed by the scope of the invention.

In the illustrated embodiment of FIG. 2, the second node B performs the fusion algorithm 12, whereby the replicated processable sensor data S2′ are stored in the second node B, which is accessed by the fusion algorithm 12. The result of the fusion algorithm 12, namely the evaluated processable sensor data S3, are output from the fusion algorithm 12 and stored in the second memory function 10′.

Subsequently, the evaluated processable sensor data S3 are also replicated and transferred to the first memory function 10 of node A by the data communication connection 16. The first memory function 10 stores the replicated evaluated processable sensor S3′ and provides the processable data S2 and the replicated evaluated processable sensor data S3′ to the application 14 for further use.

Since both data replication S2 to S2′ and S3 to S3′ are performed as soon as updated sensor output data S1 are available, the data stored in both memory functions 10, 10′ are in most cases more or less identical.

It should also be mentioned that according to a further preferred embodiment of the invention, the first node A can be a laptop, which is physically connected to the vehicle sensors via a CAN-bus, and the second node B can be a further laptop or an xPC Target computer (see xPC Target 4.2 data sheet available on http://www.mathworks.com/products/xpctarget/?BB=1), which is connected to the first laptop via Ethernet. In this case the application may also contain a graphical user interface (GUI) for providing a visualization of e.g. the processable sensor data S2 and the evaluated processable data S3. This implementation is particularly useful during system development for evaluation purposes.

### LIST OF REFERENCES

1 system
2 data communication connection, e.g. CAN-bus
4 sensor assembly comprising at least one sensor
6 CAN-reader
8 filter function
10 first memory function
10′ second memory function
12 fusion algorithm
14 application
16 data communication connection, e.g. Ethernet
S1 “raw” sensor output data
S2 processable sensor data
S2′ replicated processable sensor data S2
S3 further processed (evaluated) processable sensor data
S3′ replicated further processed (evaluated) processable sensor data S3
A first node
B second node

1. Method for preparing sensor output data (S1) of a sensor assembly (4) comprising at least one sensor for further processing in at least one application (14) and/or by at least one algorithm (12), the method comprising a configuration phase and/or an operational phase, wherein the operational phase comprises the steps of:
Providing a data manipulation structure comprising a filter function (8) for transforming the sensor output data (S1) into processable sensor data (S2) and at least a first memory function (10) for storing the processable sensor data (S2);
Transforming the sensor output data (S1) from the sensor assembly (4) into processable sensor data (S2) processable by the at least one application (14) and/or the at least one algorithm (12) by means of the filter function (8);
Storing the processable sensor data (S2) by means of the at least first memory function (10); and
Providing the stored processable sensor data (S2) to the at least one application (14) and/or the at least one algorithm (12) for further processing.

2. Method according to claim 1, wherein the data manipulation structure is configured during the configuration phase by:
(i) automatically generating a set of data derived from a sensor and data specification file of the sensor assembly (4), said set of data including filter function data for configuring at least one filter function (8) for translating the sensor output data (S1) into processable sensor data (S2); and
(ii) automatically configuring the at least one filter function (8) based on said filter function data.

3. Method according to claim 1 or 2, wherein the data manipulation structure is configured during the configuration phase by:
(i) automatically generating the set of data derived from a sensor and data specification file of the sensor assembly (4), said set of data including memory function data for configuring at least one memory function (10, 10′) for storing processable sensor data (S2); and
(ii) automatically configuring the at least one memory function (10, 10′) based on said memory function data.

4. Method for preparing sensor output data (S1) of a sensor assembly (4) comprising at least one sensor for further processing in at least one application (14) and/or by at least one algorithm (12), the method comprising a configuration phase and/or an operational phase, wherein the configuration phase comprises the steps of:
automatically generating a set of data derived from a sensor and data specification file of the sensor assembly (4), said set of data including filter function data for configuring at least one filter function (8) for translating the sensor output data (S1) into processable sensor data (S2), and said set of data including memory function data for configuring at least one memory function (10, 10′) for storing the processable sensor data (S2); and
automatically configuring the at least one filter function (8) and the at least one memory function (10, 10′) based on said filter and memory function data.

5. Method according to claim 3 or 4, wherein, within the step of configuring a data manipulation structure, the step of automatically generating a set of data includes data for configuring at least one second memory function (10′) for storing a replication (S2′) of the processable sensor data (S2) stored in the first memory function (10) and/or further processed processable sensor data (S3).

6. Method according to any one of the preceding claims, wherein the step of configuring the data manipulation structure is only performed when the sensor assembly (4) is taken into operation for the first time or when the sensor and data specification file of the sensor assembly (4) has been changed or, after an existing sensor assembly (4) has been replaced by a new sensor assembly, when the new sensor assembly is taken into operation for the first time or when the sensor and data specification file of the new sensor assembly (4) has been changed, particularly due to removal, exchange or addition of sensors.

7. Method according to any one of the preceding claims, wherein the steps of the configuration phase are performed on a remote processing device.

8. Method according to any one of the preceding claims, further comprising, in the subsequent operational phase, at least one of the following steps:
Storing the processable sensor data (S2) in the first memory function (10);
Replicating the processable sensor data (S2) for generating replicated processable sensor data (S2′);
Storing the replicated processable sensor data (S2′) in one of the first or second memory function (10, 10′) or in both, preferably in the second memory function (10′);
processing the replicated processable sensor data (S2′) by means of at least one further application (14) and/or at least one further algorithm (12) for generating further processed processable sensor data (S3);
storing the further processed processable sensor data (S3) in one of the first or second memory function (10, 10′) or in both, preferably in the second memory function (10′);
Replicating the further processed processable sensor data (S3) for generating replicated further processed processable sensor data (S3′);
Storing the replicated further processed processable sensor data (S3′) in one of the first or second memory function (10, 10′) or in both, preferably in the first memory function (10); and
Providing (i) the processable sensor data (S2) and the replicated further processed processable sensor data (S3′) or (ii) the replicated processable sensor data (S2′) and the further processed processable sensor data (S3) to the at least one application (14) and/or the at least one algorithm for further processing.

9. Method according to any one of the preceding claims, wherein the algorithm (12) is a fusion algorithm for comparing and evaluating sensor data.

10. System for preparing sensor output data (S1) from a sensor assembly (4) comprising at least one sensor for further processing in at least one application (14) and/or at least one algorithm (12), the system (1) comprising one or more nodes (A; B), each node (A; B) comprising at least one processor and/or at least one storage, wherein the node (A; B) further has an input for receiving the sensor output data (S1) and is adapted to perform a method according to any one of claims 1 to 9.

11. System according to claim 10, wherein the node (A; B) further comprises an interface for receiving the sensor and data specification file of the sensor assembly (4) for the automatic generation of the data manipulation structure and is adapted to integrate the data manipulation structure.

12. System according to claim 10 or 11, wherein the node (A; B) is further adapted to execute the at least one application (14) or comprises an output for outputting processable sensor data (S2) for the at least one application (14).

13. System according to any one of claims 10 to 12, wherein the node (A; B) is further adapted to execute the at least one algorithm (12), in particular a fusion algorithm (12) for comparing and evaluating sensor data.

14. System according to claim 13, wherein the at least one algorithm (12) and/or the at least one application (14) are executed in different nodes (A; B).

15. System according to any one of claims 10 to 14, comprising a first node (A) and at least a second node (B), which is connected at least to the first node (A), wherein the first node (A) is adapted to integrate the filter function (8) for translating the sensor output data (S1) into processable sensor data (S2) and the first memory function (10) for storing the processable sensor data (S2) or the replicated further processed processable sensor data (S3′), and the second node (B) is adapted to integrate the second memory function (10′) for storing the replicated processable sensor data (S2′) and/or the further processed processable sensor data (S3).

16. System according to claim 15, wherein
the first node (A) further comprises at least one transceiver for transferring the replicated processable sensor data (S2′) of the first memory function (10) to the second node (B) and/or for receiving a replication of the further processed processable sensor data (S3′) of the second memory function (10′) from the second node (B); and/or
the second node (B) comprises at least one transceiver for transferring the replicated further processed processable sensor data (S3′) of the second memory function (10′) to the first node (A) and/or for receiving the replicated processable sensor data (S2′) of the first memory function (10) from the first node (A).

17. System according to claim 15 or 16, wherein the nodes (A; B) are connected with each other by a wired or wireless data transfer connection (16).

18. System according to any one of claims 10 to 17, wherein the at least one node (A; B) is connected to the sensor assembly (4) by means of a wired or wireless data transfer connection (2), preferably by means of a CAN-bus.

19. A vehicle, particularly a truck, comprising a sensor assembly (4) comprising at least one sensor for providing sensor output data (51), a system (1) for preparing said sensor output data (S1) for further processing in at least one application (14) and/or at least one algorithm (12) according to any one of claims 10 to 18 and the at least one application (14) and/or the at least one algorithm (12) for further processing of said prepared sensor output data, wherein the sensor output data (S1) are provided to the at least one application (14) and/or the at least one algorithm (12) via the system (1) by a method according to any one of claims 1 to 9.

20. A computer program product comprising a software code to be executed on a remote processor or on a processor being part of the system according to any one of claims 10 to 18 for generating a data manipulation structure, which is used to perform a method according to any one of claims 1 to 9, wherein preferably the computer program is stored on a computer readable medium or adapted to be downloaded from the internet.

21. A computer program product comprising a software code to be executed on a processor being part of the system according to any one of claims 10 to 18 for performing a method according to any one of claims 1 to 9, wherein the computer program preferably is stored on a computer readable medium or adapted to be downloaded from the internet.
